(19) United States
(12) Patent Application Publication
(10) Pub. No.: US 2026/0310676 A1
(43) Pub. Date: Oct. 8, 2026

(54) METHOD OF DISPLAYING SEARCH INFORMATION, COMPUTER DEVICE AND STORAGE MEDIUM

(71) Applicant: Beijing Zitiao Network Technology Co., Ltd., Beijing (CN)

(72) Inventors: Liping ZHU, Beijing (CN); Hui GAO, Beijing (CN)

(21) Appl. No.: 19/108,390

(22) PCT Filed: Apr. 24, 2024
(86) PCT No.: PCT/CN2024/089540

§ 371 Date: Mar. 3, 2025

(30) Foreign Application Priority Data
May 10, 2023 (CN) 202310524979.1

(51) Int. Cl. G06F 16/248

(52) U.S. Cl. CPC G06F 16/248

(57) ABSTRACT

A method of displaying search information, a computer device and a storage medium are provided. The method includes: in response to receiving a search term, acquiring first search index information of a target event associated with the search term and search keywords of the target event in different attention feature dimensions, the first search index information representing a change trend of the target event over time cycles in a first preset period of time and a search index of the target event in each of the time cycles; and displaying the first search index information and the search keywords in a first search result page.

The present application claims priority to Chinese Patent Application No. 202310524979.1 filed on May 10, 2023, the entire disclosure of which is incorporated herein by reference as part of the present application.

### TECHNICAL FIELD

The present disclosure relates to a method and an apparatus of displaying search information, a computer device, and a storage medium.

### BACKGROUND

With the rapid development of Internet technologies, people can learn about various hotspot events on the Internet. Different hotspot events have different durations. For example, hotspot events with a duration of several hours, and hotspot events with a duration of several days or months are common. When a user searches for a hotspot event with a certain duration, search results provided by a conventional search engine for the user are often information such as news and information related to the event itself, and thus, there is a problem that it cannot intuitively and comprehensively reflect the hotspot event, and thus the user cannot fully and efficiently understand the hotspot event.

### SUMMARY

A method and an apparatus of displaying search information, a computer device, and a storage medium are at least provided in embodiments of the present disclosure.

According to a first aspect, an embodiment of the present disclosure provides a method of displaying search information. The method includes:
in response to receiving a search term, acquiring first search index information of a target event associated with the search term and search keywords of the target event in different attention feature dimensions, wherein the first search index information represents a change trend of the target event over time cycles in a first preset period of time and a search index of the target event in each of the time cycles; and
displaying the first search index information and the search keywords in a first search result page.

In a possible implementation, the attention feature dimension is related to a development stage of the target event.

The search keyword is determined according to the following steps:
determining a target development stage of the target event; and.
determining respective attention feature dimensions corresponding to the target event according to the target development stage, and determining respective search keywords corresponding to the respective attention feature dimensions from full search terms related to the target event.

In a possible implementation, the determining respective search keywords corresponding to the respective attention feature dimensions from full search terms related to the event includes:
determining, for any one of the attention feature dimensions, respective initial search terms with a degree of association with respect to the attention feature dimension greater than a preset degree of association from the full search terms; and
screening, according to search indices of the respective initial search terms in each of the time cycles in the first preset period of time, the search keyword in the attention feature dimension from the initial search terms.

In a possible implementation, the attention feature dimension is related to a user attention feature corresponding to the target event, and the user attention feature is determined in real time according to historical consumption data of respective historical search terms in the target event.

The search keyword is determined according to the following steps:
determining a user attention feature corresponding to the target event according to time when the search term is received, and using the user attention feature as the attention feature dimension;
determining respective to-be-used keywords corresponding to the respective attention feature dimensions from full search terms related to the target event; and
for any one of the attention feature dimensions, screening, according to a degree of correlation between the search term and a to-be-used keyword in the attention feature dimension and a search index of the to-be-used keyword in each of the time cycles in the first preset period of time, the search keyword in the attention feature dimension from the to-be-used keywords.

In a possible implementation, after displaying the search keyword, the method further includes:
in response to triggering the search keyword, displaying, in the first search result page, second search index information corresponding to the search keyword, wherein the second search index information represents a change trend of the search keyword over time cycles in the first preset period of time and a search index of the search keyword in each of the time cycles.

In a possible implementation, before displaying, in the first search result page, the second search index information corresponding to the search keyword, the method further includes:
acquiring respective to-be-displayed entries corresponding to the search keyword, wherein the to-be-displayed entry is determined according to degrees of correlation between respective to-be-screened entries and the search keyword and search indices of the to-be-screened entries in a second preset period of time.

The displaying, in the first search result page, the second search index information corresponding to the search keyword includes:
displaying the second search index information below the search keyword and displaying the respective to-be-displayed entries below the second search index information.

In a possible implementation, after displaying the second search index information below the search keyword, the method further includes:
in response to a trigger operation on the second search index information, determining a target time cycle triggered by the trigger operation; and
displaying search data information corresponding to the target time cycle, wherein the search data information is determined according to result attributes of at least one clustering result obtained by performing result clustering on search results of the respective to-be-displayed entries corresponding to the search keyword in the target time cycle.

In a possible implementation, the second search index information corresponding to the search keyword is determined according to the following steps:
acquiring a first search index of the search keyword in each of the time cycles in the first preset period of time and acquiring a second search index of each of search terms related to the search keyword in each of the time cycles in the first preset period of time;
determining a search index of the search keyword in the time cycle according to the first search index of the search keyword in the time cycle and the second search index of each of the search terms in the time cycle for each of the time cycles; and
determining the second search index information corresponding to the search keyword according to the search index of the search keyword in each of the time cycles.

In a possible implementation, after displaying the respective to-be-displayed entries, the method further includes:
in response to triggering the to-be-displayed entry, acquiring a search result matching a triggered to-be-displayed entry; and
displaying the search result in a second search result page.

According to a second aspect, an embodiment of the present disclosure further provides an apparatus of displaying search information. The apparatus includes:
an acquisition module, configured to, in response to receiving a search term, acquire first search index information of a target event associated with the search term and search keywords of the target event in different attention feature dimensions, wherein the first search index information represents a change trend of the target event over time cycles in a first preset period of time and a search index of the target event in each of the time cycles; and
a display module, configured to display the first search index information and the search keywords in a first search result page.

According to a third aspect, an optional implementation of the present disclosure further provides a computer device, a processor and a memory. The memory stores machine-readable instructions being capable of being executed by the processor. The processor is configured to execute the machine-readable instructions stored in the memory. When executing the machine-readable instructions, the processor performs the steps in the first aspect or any possible implementation of the first aspect.

According to a fourth aspect, an optional implementation of the present disclosure further provides a computer-readable storage medium. The computer-readable storage medium is stored with a computer program thereon, and when the computer program is run, the steps in the first aspect or any possible implementation of the first aspect are executed.

Reference is made to the description of the method of displaying search information for the description of the effects of the apparatus of displaying search information, the computer device, and the computer-readable storage medium, which will not be repeated here.

In order to make the above objects, features, and advantages of the present disclosure more comprehensible, the following specific embodiments are described in detail with reference to the drawings.

### BRIEF DESCRIPTION OF DRAWINGS

In order to more clearly illustrate the technical solutions of the embodiments of the present disclosure, the drawings that need to be used in the embodiments will be briefly described below. The drawings are incorporated into and constitute a part of this specification. The drawings illustrate embodiments that conform to the present disclosure and are used together with the specification to illustrate the technical solutions of the present disclosure. It should be understood that the following drawings only illustrate some embodiments of the present disclosure, and thus should not be considered as limiting the scope of the present disclosure. For those of ordinary skill in the art, other relevant drawings may be obtained according to these drawings without creative effort.

FIG. 1 shows a flowchart of a method of displaying search information provided by an embodiment of the present disclosure;

FIG. 2 shows a schematic diagram of displaying a first search result page provided by an embodiment of the present disclosure;

FIG. 3 shows a schematic diagram of displaying second search index information and a to-be-displayed entry provided by an embodiment of the present disclosure;

FIG. 4 shows a schematic diagram of determining first search index information, second search index information, and a to-be-displayed entry provided by an embodiment of the present disclosure;

FIG. 5 shows a schematic diagram of a process of displaying a second search result page provided by an embodiment of the present disclosure;

FIG. 6 shows a schematic diagram of an apparatus of displaying search information provided by an embodiment of the present disclosure; and

FIG. 7 shows a schematic structural diagram of a computer device provided by an embodiment of the present disclosure.

### DETAILED DESCRIPTION

In order to make the objectives, technical solutions, and advantages of the embodiments of the present disclosure clearer, the technical solutions in the embodiments of the present disclosure will be described clearly and comprehensively in conjunction with the drawings in the embodiments of the present disclosure. Obviously, the described embodiments are only a part of the embodiments of the present disclosure, rather than all of the embodiments. The components of the embodiments of the present disclosure, which are described and illustrated herein, may be arranged and designed in various different configurations. Therefore, the following detailed description of the embodiments of the present disclosure is not intended to limit the scope of the present disclosure that is claimed, but is only representative of selected embodiments of the present disclosure. Based on the embodiments of the present disclosure, all other embodiments obtained by those of ordinary skill in the art without creative effort fall within the scope of the present disclosure.

In addition, the terms “first” and “second” in the specification and claims of the embodiments of the present disclosure and the above drawings are used to distinguish between similar objects, but are not necessarily used to describe a specific order or sequence. It should be understood that the data used in this way can be interchanged under appropriate circumstances, so that the embodiments described herein can be implemented in a sequence other than those illustrated or described herein.

As used herein, “a plurality” or “a number of” refers to two or more. “And/or” describes the association relationship between associated objects, and means that there may be three relationships, for example, A and/or B may mean: A exists alone, A and B exist at the same time, and B exists alone. The character “/” generally indicates that the associated objects before and after it are in an “or” relationship.

It is found through research that when a hotspot event is searched for, results provided for a user are often search results of types such as news, information, and videos related to a target event, and such search results are often decoupled. Through each search result, the user can often learn only part of the hotspot event. If the user wants to fully understand the hotspot event, the user needs to consume a large number of search results. In this manner, the user not only cannot intuitively fully understand the hotspot event, but also needs to consume a lot of time, and thus cannot efficiently understand the hotspot event.

Based on the above research, the present disclosure provides a method and an apparatus of displaying search information, a computer device, and a storage medium. Since the first search index information can represent a change trend of the target event over the time cycles in the first preset period of time and the search index of the target event in each of the time cycles, after the search term is received, the first search index information of the target event associated with the search term is displayed, so that the user can be helped to more intuitively and efficiently understand the search trend and search popularity of the target event. By displaying the search keywords of the target event in different attention feature dimensions, not only can the concise search keywords be used to reflect the core key points of the target event in different dimensions, but also the user can be helped to further fully understand the target event based on the displayed search keywords.

In the embodiments of the present disclosure, after the search term is received, the first search index information of the target event associated with the search term and the search keywords in the different attention feature dimensions are displayed, so that the search trend and the event popularity of the target event can be comprehensively and intuitively displayed to the user, the richness of displayed content can be improved, and the user can be helped to more comprehensively, multi-directionally, and efficiently understand the target event.

The above defects in the above solution are results obtained by the inventor which has performed practice and careful study. Therefore, the discovery process of the above problems and the solutions to the above problems provided in the present disclosure should be contributions of the inventor to the present disclosure in the process of the present disclosure.

It should be noted that similar reference numerals and letters in the following drawings represent similar items. Therefore, once an item is defined in a drawing, it does not need to be further defined and explained in subsequent drawings.

It should be understood that before using the technical solutions disclosed in the embodiments of the present disclosure, users should be informed of the type, usage scope, usage scenario, etc. of the personal information involved in the present disclosure through appropriate means according to relevant laws and regulations, and the authorization of the users should be obtained.

In order to facilitate understanding of this embodiment, a method of displaying search information disclosed in an embodiment of the present disclosure is first described in detail. An execution body of the method of displaying search information provided in the embodiment of the present disclosure is generally a terminal device or another processing device with a certain computing capability, where the terminal device may be a user equipment (User Equipment, UE), a mobile device, a user terminal, a terminal, a personal digital assistant (Personal Digital Assistant, PDA) device, a handheld device, a computer device, etc. In some possible implementations, the method of displaying search information may be implemented by a processor calling computer-readable instructions stored in a memory.

The method of displaying search information provided in the embodiment of the present disclosure is described below by using an example in which the execution body is a computer device.

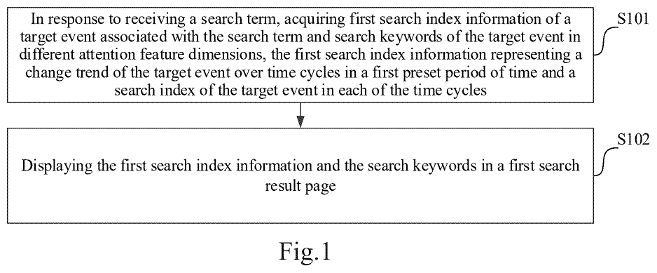

As shown in FIG. 1, FIG. 1 is a flowchart of a method of displaying search information provided by an embodiment of the present disclosure. The method may include the following steps.

In S101, in response to receiving a search term, first search index information of a target event associated with the search term and search keywords of the target event in different attention feature dimensions are acquired, where the first search index information represents a change trend of the target event over time cycles in a first preset period of time and a search index of the target event in each of the time cycles.

Here, the target event may be a hotspot event associated with the search term, and a degree of correlation between the target event and the search term may be greater than a preset correlation threshold. The attention feature dimension is used to indicate a dimension of an event that is focused on. For example, the attention dimension may be a number of views dimension (i.e., a popularity dimension), a timeliness dimension, an authority dimension, and the like. At least one search keyword may correspond to one attention feature dimension, and search keywords corresponding to different attention feature dimensions may be different or partially repeated.

The search keyword may be respective keywords associated with the target event. It may be understood that the search keyword may be a keyword in full search terms corresponding to various searches initiated by the target event when the target event occurs.

The first preset period of time may be a historical time cycle, for example, the past one day, the past 7 days, the past 30 days, the past 60 days, and the like. The first preset period of time may be set according to experience, which is not specifically limited in the embodiments of the present disclosure. The time cycle may be set according to a size of the first preset period of time. For example, in a case where the first preset period of time is the past one day, the time cycle may be 1 hour; in a case where the first preset period of time is the past 30 days, the time cycle may be one day.

The search index of the target event is used to measure search popularity of the target event, and may be obtained by performing weighted summation on search volume of full search terms related to the target event corresponding to the first preset period of time and/or search volume of search results related to the target event. One search index corresponds to one time cycle.

In a specific implementation, in response to receiving the search keyword, the search term is sent to a server, and the server may first determine the target event associated with the search term, then determine the first search index information corresponding to the target event in the first time cycle, and at the same time, determine respective attention feature dimensions corresponding to the target event and determine the search keyword in each attention feature dimension. Then, the server may feedback the first search index information and the search keyword, so that the first search index information and the respective search keywords may be acquired.

Optionally, in addition to the search keyword, a search index of each of the search keywords in a second preset period of time may also be acquired. For example, search indices of the respective search keywords in the past one day may be acquired.

Optionally, the attention dimension may also be determined according to search indices corresponding to the full search terms associated with the target event. For example, the second preset period of time may be sorted according to search indices of the respective full search terms in the second preset period of time in a descending order, respective full search terms with a ranking order less than a preset order are used as the search keywords, and each search keyword is used as an attention feature dimension.

In an embodiment, the attention feature dimension may be related to a development stage of the target event, that is, when the target event is in different development stages, the target event corresponds to different attention feature dimensions. The development stage of the target event may include a start stage, a rise stage, a peak stage, a fall stage, and an end stage.

In a case where the attention feature dimension is related to the development stage of the target event, the search keyword in the attention feature dimension may be determined according to the following steps.
Step 1: determining a target development stage at which the target event is.
Step 2: determining respective attention feature dimensions corresponding to the target event according to the target development stage, and determining respective search keywords corresponding to the respective attention feature dimensions from full search terms related to the target event.

Here, the full search terms are various historical search terms related to the target time, which are acquired with authorization of the user from the start of the target event to the present.

In a specific implementation, a development stage at which the target event is at the current time may be determined, and the development stage is used as the determined target development stage. Alternatively, the target development stage of the target event may be determined according to time when the search term is received and a time cycle corresponding to each development stage of the target time. Then, respective attention feature dimensions corresponding to the target display stage are determined according to the target development stage and the type of the target event. Then, for each attention feature dimension, respective search terms in the attention feature dimension may be determined from the full search terms, and then the search keyword in the attention feature dimension is screened out according to search indices of the search terms.

Exemplarily, in a case where the target event is “XX disease”, in a case where the target development stage is the start stage, the attention feature dimension may be a disease prevention dimension, a disease judgment dimension, a disease encyclopedia dimension, and the like; then, respective search keywords corresponding to the disease prevention dimension, the disease judgment dimension, and the disease encyclopedia dimension may be determined. In a case where the target development stage is the end stage, the attention feature dimension may be a disease prognosis dimension, a disease condition statistics dimension, and the like; then, respective search keywords corresponding to the disease prognosis dimension and the disease condition statistics dimension may be determined.

In this manner, since different events, or even different stages of an event, may require different feature dimensions to be focused on, the determined target development stage is used to determine the attention feature dimension, and then the attention feature dimension is used to determine the search keyword, so that the rationality and accuracy of the determined search keyword can be improved.

In an embodiment, the step of determining the search keyword in Step 2 may be performed according to the following steps.

For any one of the attention feature dimensions, respective initial search terms with a degree of association with the attention feature dimension greater than a preset degree of association are determined from the full search terms. The search keyword in the attention feature dimension is screened from the initial search terms according to search indices of the respective initial search terms in each of the time cycles in the first preset period of time.

The search index of the search term is used to measure search popularity of the search term, and may be obtained by performing weighted summation on search volume of the search term and/or search volume of search results related to the search term.

Taking an example in which the first preset period of time is the past 30 days and the time cycle is one day, for any one of the attention feature dimensions, a degree of association between each of the search terms in the full search terms and the attention feature dimension may be calculated first, and search terms with degrees of association greater than the preset degree of association are used as the initial search terms. Then, for each of the initial search terms, a search index of the initial search term in each day of the past 30 days may be acquired, and the search indices of the initial search term in the each day are summed to obtain a total search index corresponding to the initial search term. Then, the respective initial search terms may be sorted in a descending order of the total search indices according to the total search indices corresponding to the respective initial search terms, and an initial search term with a ranking order greater than a preset order is used as the search keyword in the attention feature dimension. For example, the preset order may be 10, that is, an initial search term with a total search index in a top 10 may be used as the search keyword in the attention feature dimension.

Alternatively, search indices of the respective initial search terms in the past one day may be used to sort the respective initial search terms in a descending order of the search indices, and an initial search term with a ranking order greater than the preset order is used as the search keyword in the attention feature dimension.

In another embodiment, the attention feature dimension may be related to a user attention feature corresponding to the target event, and the user attention feature is determined in real time according to historical consumption data of respective historical search terms in the target event. The user attention feature is an event feature that the user focuses on in the target event. The historical consumption data is consumption data acquired with authorization of the user, and may be historical consumption data of all network users or historical consumption data of the user who inputs the search term (that is, the user who currently initiates the search), which may specifically include the number of searches of the respective historical search terms and the consumption situation of the search results of the historical search terms (such as whether the search results are clicked, whether the search results are viewed, and whether the search results are added to favorites).

The step of determining the search keyword may also be performed according to the following steps.

A user attention feature corresponding to the target event is determined according to time when the search term is received, and the user attention feature is used as the attention feature dimension.

Exemplarily, the time when the search term is received is the current time, and the user attention feature may be determined according to acquired historical consumption data other than the current time. For example, at least one user attention feature corresponding to the current time may be determined according to the number of searches of the respective historical search terms, search intents, and the consumption situation of the search results. Alternatively, a preset time range to which the time belongs may be determined according to the time when the search term is received, and then at least one user attention feature corresponding to the preset time range may be determined. The preset time range may be determined according to the target event, each target event may correspond to a plurality of different preset time ranges, and the preset time ranges corresponding to different target events may be different.

After the respective user attention features are determined, the respective user attention features may be used as the attention feature dimensions, respectively.

Then, respective to-be-used keywords corresponding to the respective attention feature dimensions may be determined from the full search terms related to the target event.

Exemplarily, for any one of the attention feature dimensions, a degree of association between each of the search terms in the full search terms and the attention feature dimension may be calculated first, and search terms with degrees of association greater than a preset degree of association are used as the to-be-used keywords.

Then, for any one of the attention feature dimensions, the search keyword in the attention feature dimension is screened from the to-be-used keywords according to a degree of correlation between the search term and the to-be-used keyword in the attention feature dimension and a search index of the to-be-used keyword in each of the time cycles in the first preset period of time.

For any one of the attention feature dimensions, taking an example where the first preset period of time is the past 30 days and the time cycle is one day, for each to-be-used keyword in the attention feature dimension, a degree of correlation between the to-be-used keyword and the search term may be determined according to semantics of the to-be-used keyword and the search term. At the same time, a search index of the to-be-used keyword in each day of the past 30 days may be acquired, and a total search index of the to-be-used keyword is determined according to search indices corresponding to the past 30 days. Then, a to-be-used keyword with a total search index greater than a preset index and with a degree of correlation with respect to the search term greater than a preset degree of correlation is used as the search keyword in the attention feature dimension.

Alternatively, different preset weights may be set for the degree of correlation and the total search index, and for each to-be-used keyword, weighted summation may be performed on the degree of correlation and the total search index by using a corresponding preset weight to obtain a weighted value corresponding to the to-be-used keyword. The respective to-be-used keywords are sorted in a descending order of the weighted values according to the weighted value of each to-be-used keyword, and the to-be-used keyword with a ranking order less than the preset order is used as the search keyword in the attention feature dimension.

Alternatively, the to-be-used keyword with a degree of correlation with the search term greater than the preset degree of correlation may be screened out first, and then the respective to-be-used keywords are sorted in a descending order of search indices according to a total search index (or a search index in the past one day) of the screened to-be-used keyword, and the to-be-used keyword with a ranking order less than the preset order is used as the search keyword in the attention feature dimension.

In S102, displaying the first search index information and the search keyword in a first search result page.

In a specific implementation, the first search index information may be displayed in a form of a search trend graph, and the respective search keywords are displayed below the first search index information, in a result card in the first search result page. At the same time, the result card may also display an event name of the target event. A display priority of the search keyword may be determined according to a search index of the search keyword in the second preset period of time. Exemplarily, the higher the search index, the higher the display priority.

It may be understood that, in addition to displaying the first search index information and the search keyword in the search result page, the search result matching the search term may also be displayed in the search result page.

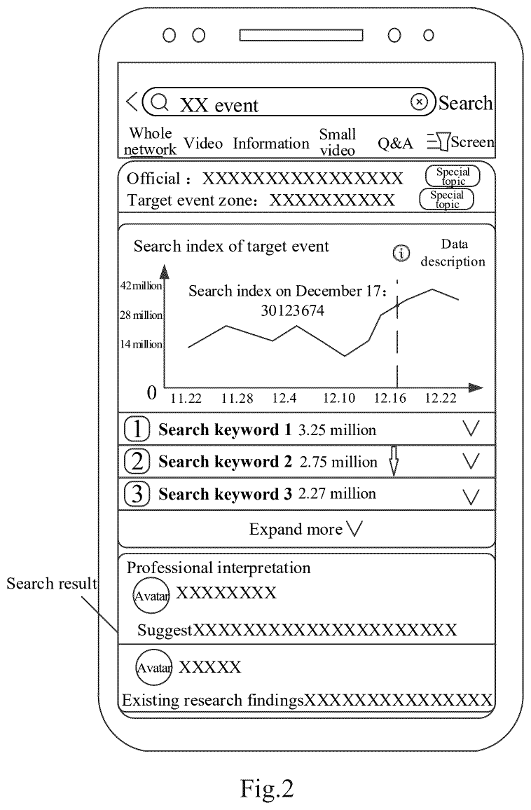

As shown in FIG. 2, FIG. 2 is a schematic diagram of displaying a first search result page provided by an embodiment of the present disclosure. The search information is “XX event”, and in a result card, the first search index information is displayed in a form of a search trend graph, and three search keywords (i.e., search keywords 1 to 3) are displayed below the search trend graph. A search index of each search keyword in the second preset period of time is also displayed beside each search keyword. A “Expand more” button is further displayed below the search keyword 3, and more search keywords may be acquired by triggering the button. Search results matching the search term are further displayed below the result card.

In this manner, after the search term is received, the first search index information of the target event associated with the search term and the search keywords in the different attention feature dimensions are displayed, so that the search trend and the event popularity of the target event can be comprehensively and intuitively displayed to the user, the richness of displayed content can be improved, and the user can be helped to more comprehensively, multi-directionally, and efficiently understand the target event.

In an embodiment, after the search keyword is displayed, the search keyword may also be triggered to acquire related information of the search keyword. Specifically, in response to triggering the search keyword, second search index information corresponding to the search keyword is displayed in the first search result page, where the second search index information represents a change trend of the search keyword over time cycles in the first preset period of time and a search index of the search keyword in each of the time cycles.

Here, the operation of triggering the search keyword may be an operation of clicking the search keyword. The second search index information is search index information of the search keyword, and may include the change trend of the search keyword over the time cycles in the first preset period of time and the search index of the search keyword in each of the time cycles. The second search index information may be obtained by performing weighted summation on search volume of the search keyword in the first preset period of time and search volume of search results related to the search keyword.

Exemplarily, in response to triggering the search keyword 1 in FIG. 2, the second search index information corresponding to the search keyword 1 may be displayed below the search keyword 1 displayed in the first search result page in a form of a search trend graph.

In this manner, after the search keyword is triggered, the user can be helped to quickly and efficiently acquire the search popularity information of the search keyword by directly displaying the second search index information of the search keyword in the first search result page.

In an embodiment, before displaying the second search index information corresponding to the search keyword in the first search result page, respective to-be-displayed entries corresponding to the search keyword may also be acquired first, and the to-be-displayed entry is determined according to degrees of correlation between respective to-be-screened entries and the search keyword and search indices of the to-be-screened entries in a second preset period of time.

Here, the to-be-screened entry may be respective historical search entries including the search keyword, and the to-be-displayed entry is a part of entries screened from the to-be-screened entries. The second preset period of time may be a historical time cycle, for example, the past one hour, the past one day, and the like. The second preset period of time may be set according to experience, which is not specifically limited in the embodiments of the present disclosure. A time length corresponding to the second preset period of time may be less than a time length of the first preset period of time. Exemplarily, in a case where the first preset period of time is the past 30 days, the second preset period of time may be the past one day. Each to-be-screened entry corresponds to one search index in the second preset period of time.

Exemplarily, in a case where the first preset period of time is the past 30 days and the second preset period of time may be the past one day, respective to-be-screened entries including the search keyword in the past 30 days may be acquired, and then for each to-be-screened entry, a degree of correlation between the to-be-screened entry and the search keyword may be calculated according to semantics of the to-be-screened entry and semantics of the search keyword, and at the same time, a search index of the to-be-screened entry in the past one day may be acquired. Then, an intermediate entry with a degree of correlation greater than a preset degree of correlation may be screened out from the to-be-screened entry by using degrees of correlation between the respective to-be-screened entries and the search keyword, and then, the respective intermediate entries may be sorted in a descending order according to search indices of the respective intermediate entries in the past one day, and then an intermediate entry with a ranking order less than a preset order may be used as the to-be-displayed entry corresponding to the search keyword. In this manner, the respective to-be-displayed entries corresponding to the search keyword may be acquired when the search keyword is triggered. For example, in a case where the search keyword is a symptom, the to-be-displayed entry corresponding to the search keyword may be “symptom diagram in 1 to 7 days”, “symptoms of mild cases”, “symptoms of people of different ages”, “possible symptoms in 1 to 7 days”, and the like.

Further, the step of “displaying the second search index information corresponding to the search keyword in the first search result page” may be performed according to the following steps:
displaying the second search index information below the search keyword, and displaying the respective to-be-displayed entries below the second search index information.

Exemplarily, the second search index information of the triggered search keyword may be displayed below the triggered search keyword in a form of a search trend graph, and the respective to-be-displayed entries corresponding to the search keyword are displayed below the displayed second search index information.

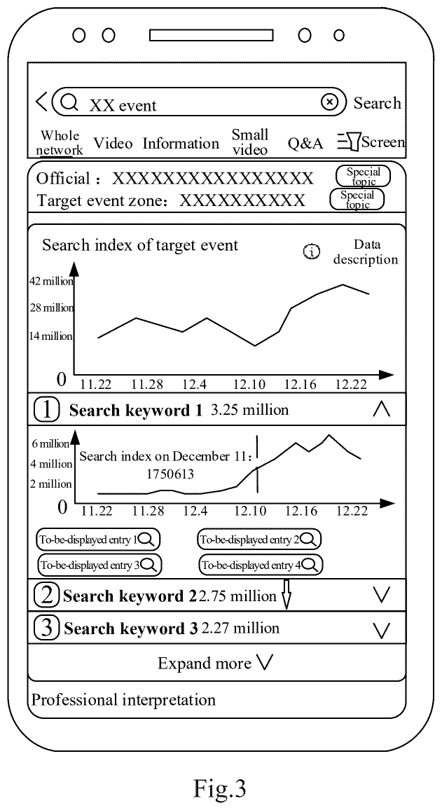

As shown in FIG. 3, FIG. 3 is a schematic diagram of displaying second search index information and a to-be-displayed entry provided by an embodiment of the present disclosure. FIG. 3 may be a page obtained by triggering the search keyword 1 in FIG. 2, and the second search index information corresponding to the search keyword 1 is displayed below the search keyword 1 in a form of a search trend graph. In addition, four to-be-displayed entries (i.e., “to-be-displayed entries 1 to 4” in FIG. 3) corresponding to the search keyword 1 are displayed below the displayed second search index information, where each to-be-displayed entry may include the search keyword 1.

In an implementation, after the second search index information is displayed in a form of a search trend graph, in response to a click operation on the search trend graph corresponding to the second search index information, a target time cycle corresponding to the click operation may also be determined, and a search index of the search keyword in the target time cycle is displayed. For example, in FIG. 3, the triggered target time cycle is December 11, and therefore the search index of the search keyword 1 (1750613 in FIG. 3) on December 11 may be displayed in the search trend graph. The target time cycle is the time cycle triggered by the click operation. In FIG. 3, the search trend graph has a corresponding curve, and each position in the curve corresponds to one time cycle. The click operation on the search trend graph may be an operation of clicking any position in the curve corresponding to the search trend graph.

Optionally, after the first search index information is displayed in a form of a search trend graph, in response to a click operation on the search trend graph corresponding to the first search index information, a target time cycle corresponding to the click operation may also be determined, and a search index of the target event in the target time cycle is displayed. For example, in FIG. 2, the triggered target time cycle is December 17, and therefore the search index of the target event (30123674 in FIG. 2) on December 17 may be displayed in the search trend graph.

In an embodiment, the second search index information corresponding to the search keyword may be determined according to the following steps:

S1: acquiring a first search index of the search keyword in each of the time cycles in the first preset period of time, and acquiring a second search index of each of search terms related to the search keyword in each of the time cycles in the first preset period of time.

Here, the first search index is the search index of the search keyword in each of the time cycles in the first preset period of time, and the second search index is the search index of the search entry in each of the time cycles in the first preset period of time. The search entries related to the search keyword may be respective historical search entries including the search keyword and/or historical search entry derived from the search keyword.

Exemplarily, the first search index of the search keyword in each day of the past 30 days may be acquired, and the second search index of each of the search entries related to the search keyword in each day of the past 30 days may be acquired.

S2: for each of the time cycles, determining a search index of the search keyword in the time cycle according to the first search index of the search keyword in the time cycle and the second search index of each of the search entries in the time cycle.

Exemplarily, for each of the time cycles, the first search index of the search keyword in the time cycle and the second search index of each of the search entries in the time cycle may be summed to obtain the search index of the search keyword in the time cycle.

Alternatively, for each of the time cycles, a first weight preset for the first search index and a second weight preset for the second search index may be acquired; the first search index of the search keyword in the time cycle is weighted by using the first weight to obtain a first weighted value; the second search index of each of the search entries in the time cycle is weighted by using the second weight to obtain a second weighted value corresponding to each of the search entries in the time cycle; and the first weighted value and the respective second weighted values are added to obtain the search index of the search keyword in the time cycle.

S3: determining the second search index information corresponding to the search keyword according to the search index of the search keyword in each of the time cycles.

In a specific implementation, after the search index of the search keyword in each of the time cycles is obtained, the change trend of the search keyword over the time cycle in the first preset period of time may be determined according to the search index of the search keyword in each of the time cycles, and then the change trend and the search index of the search keyword in each of the time cycles may be combined to obtain the second search index information corresponding to the search keyword.

Similarly, for the first search index information of the target event, a search index of the target event in each of the time cycles may be determined according to search indices of the full search terms related to the target event in the respective time cycles and the number of views of the search results of the full search terms in the respective time cycles. Then, the first search index information of the target event may be generated according to the search index of the target event in each of the time cycles.

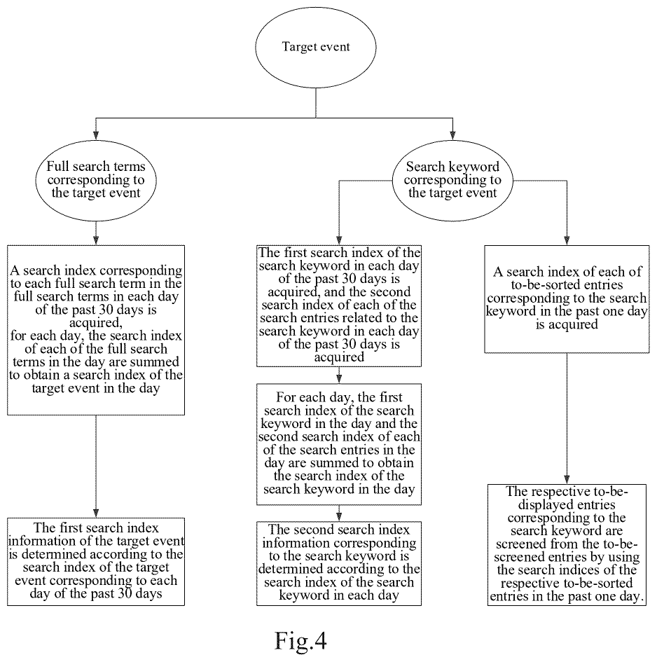

As shown in FIG. 4, FIG. 4 is a schematic diagram of determining first search index information, second search index information, and a to-be-displayed entry provided by an embodiment of the present disclosure. After the full search terms corresponding to the target event are acquired, a search index corresponding to each full search term in the full search terms in each day of the past 30 days may be acquired; for each day, search indices of the respective full search terms in the day are summed to obtain a search index of the target event in the day; and the first search index information of the target event is determined according to the search index of the target event corresponding to each day of the past 30 days. After the search keyword corresponding to the target event is acquired, the first search index of the search keyword in each day of the past 30 days may be acquired, and the second search index of each of the search entries related to the search keyword in each day of the past 30 days may be acquired; then for each day, the first search index of the search keyword in the day and the second search index of each of the search entries in the day are summed to obtain the search index of the search keyword in the day; and then the second search index information corresponding to the search keyword may be determined according to the search index of the search keyword in each day. For each search keyword, a search index of each of to-be-screened entries corresponding to the search keyword in the past one day may be acquired, and then, the respective to-be-displayed entries corresponding to the search keyword may be screened from the to-be-screened entries by using the search indices of the respective to-be-screened entries in the past one day.

In an embodiment, after the second search index information is displayed, the following steps may also be performed.

In response to a trigger operation on the second search index information, a target time cycle triggered by the trigger operation is determined. Search data information corresponding to the target time cycle is displayed. The search data information is determined according to result attributes of at least one clustering result obtained by performing result clustering on search results of the respective to-be-displayed entries corresponding to the search keyword in the target time cycle.

Here, the target time cycle is the time cycle triggered by the trigger operation. For example, in a case where the first preset period of time is the past 30 days, the target time cycle may be any one day of the past 30 days.

The result attribute is used to represent a common feature shared by the respective search results in the clustering result. For example, the result attribute may represent a common keyword, a common genre, a common intent, a common information dimension, or the like of the respective search results in the clustering result.

In a specific implementation, for the search keyword, respective search results of the respective to-be-displayed entries corresponding to the search keyword in the target time cycle may be acquired. Then, the respective search results may be clustered according to different clustering dimensions to obtain at least one clustering result. For each obtained clustering result, the result attribute of the clustering result may be determined according to a clustering dimension used when the clustering result is obtained and a common feature shared by the respective search results in the clustering result. Then, the result attribute may be used as the search data information of the search keyword in the target time cycle.

The search data information may be displayed at a trigger position corresponding to the trigger operation.

Exemplarily, in response to triggering the search trend graph corresponding to the second search index information, a trigger position in a curve corresponding to the search trend graph may be determined, and the time cycle corresponding to the position is used as the target time cycle. Then, the search data information of the search keyword in the target time cycle may be acquired, and the search data information is displayed at the trigger position in the search trend graph.

Optionally, after the first search index information is displayed, the following steps may also be performed.

In response to a trigger operation on the first search index information, a target time cycle triggered by the trigger operation is determined. Search data information corresponding to the target event in the target time cycle is displayed, where the search data information corresponding to the target event in the target time cycle may be determined according to result attributes of at least one clustering result obtained by performing result clustering on respective search results of full search terms corresponding to the target event in the target time cycle.

Reference is made to the steps of determining the search data information of the search keyword in the target time cycle described above for the steps of determining the search data information corresponding to the target event in the target time cycle, which will not be repeated here.

Exemplarily, in response to triggering the search trend graph corresponding to the first search index information, a trigger position in a curve corresponding to the search trend graph may be determined, and the time cycle corresponding to the position is used as the target time cycle. Then, the search data information corresponding to the target event in the target time cycle may be acquired, and the search data information is displayed at the trigger position in the search trend graph.

In an embodiment, after the respective to-be-displayed entries are displayed, the method may further:
in response to triggering the to-be-displayed entry, acquiring a search result matching the triggered to-be-displayed entry. The search result is displayed in a second search result page.

Here, the search result matching the triggered to-be-displayed entry is respective search results obtained by searching using the to-be-displayed entry. The second search result page is a new search result page, which is configured to display the search result matching the to-be-displayed entry.

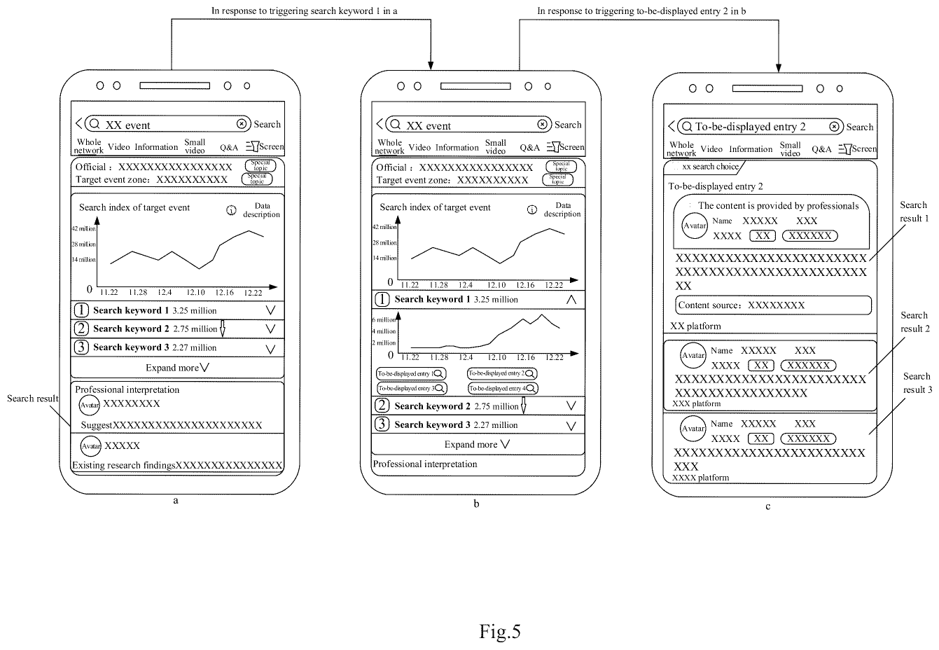

As shown in FIG. 5, FIG. 5 is a schematic diagram of a process of displaying a second search result page provided by an embodiment of the present disclosure. “a” in FIG. 5 is the above FIG. 2, and “b” in FIG. 5 may be obtained by triggering the search keyword 1 in “a”, where “b” in FIG. 5 is the above FIG. 3. After the to-be-displayed entry 2 in “b” is triggered, the second search result page shown in “c” in FIG. 5 may be generated, where search information in a search box in the second search result page is the to-be-displayed entry 2, and three search results (i.e., search results 1 to 3 in “c”) corresponding to the to-be-displayed entry 2 are displayed in the second search result page.

Those skilled in the art can understand that in the above method of the specific implementation, the writing sequence of the steps does not mean a strict execution sequence and does not constitute any limitation on the implementation process, and the specific execution sequence of the steps should be determined according to their functions and possible internal logic.

Based on the same inventive concept, an apparatus of displaying search information corresponding to the method of displaying search information is further provided in the embodiments of the present disclosure. Since the apparatus in the embodiments of the present disclosure solves the problem based on the principle similar to that of the above method of displaying search information in the embodiments of the present disclosure, the implementation of the apparatus may refer to the implementation of the method, and the repetition will not be repeated.

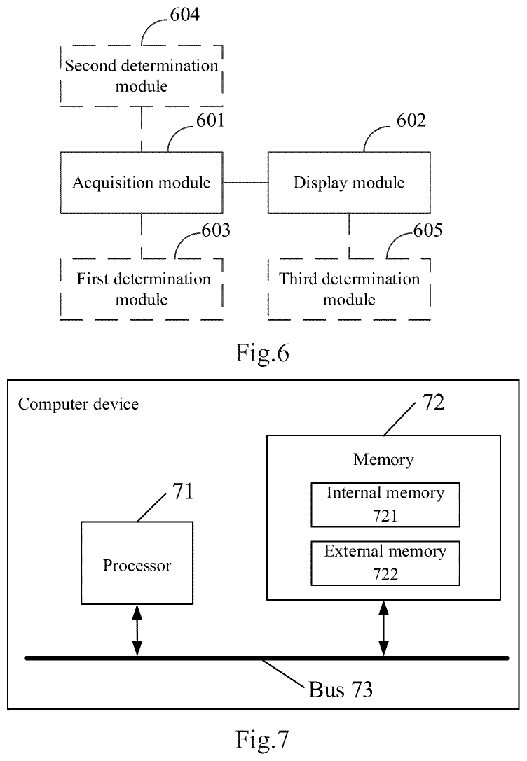

As shown in FIG. 6, FIG. 6 is a schematic diagram of an apparatus of displaying search information provided by an embodiment of the present disclosure. The apparatus includes:
an acquisition module 601, configured to in response to receiving a search term, acquire first search index information of a target event associated with the search term and search keywords of the target event in different attention feature dimensions, where the first search index information represents a change trend of the target event over time cycles in a first preset period of time and a search index of the target event in each of the time cycles; and
a display module 602, configured to display the first search index information and the search keywords in a first search result page.

In a possible implementation, the attention feature dimension is related to a development stage of the target event.

The apparatus further includes:
a first determination module 603, configured to determine the search keyword according to the following steps:
determining a target development stage at which the target event is;
determining respective attention feature dimensions corresponding to the target event according to the target development stage, and determining respective search keywords corresponding to the respective attention feature dimensions from full search terms related to the target event.

In a possible implementation, in the determining respective search keywords corresponding to the respective attention feature dimensions from full search terms related to the event, the first determination module 603 is configured to:
determine, for any one of the attention feature dimensions, respective initial search terms with a degree of association with respect to the attention feature dimension greater than a preset degree of association from the full search terms; and
screen, according to search indices of the respective initial search terms in each of the time cycles in the first preset period of time, the search keyword in the attention feature dimension from the initial search terms.

In a possible implementation, the attention feature dimension is related to a user attention feature corresponding to the target event, and the user attention feature is determined in real time according to historical consumption data of respective historical search terms in the target event.

The apparatus further includes:
a second determination module 604, configured to determine the search keyword according to the following steps:
determining a user attention feature corresponding to the target event according to time when the search term is received, and using the user attention feature as the attention feature dimension;
determining respective to-be-used keywords corresponding to the respective attention feature dimensions from full search terms related to the target event; and
for any one of the attention feature dimensions, screening, according to a degree of correlation between the search term and a to-be-used keyword in the attention feature dimension and a search index of the to-be-used keyword in each of the time cycles in the first preset period of time, the search keyword in the attention feature dimension from the to-be-used keywords.

In a possible implementation, the display module 602 is further configured to, after displaying the search keyword,
in response to triggering the search keyword, display, in the first search result page, second search index information corresponding to the search keyword, where the second search index information represents a change trend of the search keyword over time cycles in the first preset period of time and a search index of the search keyword in each of the time cycles.

In a possible implementation, the acquisition module 601 is further configured to, before displaying, in the first search result page, the second search index information corresponding to the search keyword,
acquire respective to-be-displayed entries corresponding to the search keyword, where the to-be-displayed entry is determined according to degrees of correlation between respective to-be-screened entries and the search keyword and search indices of the to-be-screened entries in a second preset period of time.

In the displaying, in the first search result page, the second search index information corresponding to the search keyword, the display module 602 is further configured to:
display the second search index information below the search keyword and display the respective to-be-displayed entries below the second search index information.

In a possible implementation, the display module 602 is further configured to, after displaying the second search index information below the search keyword,
in response to a trigger operation on the second search index information, determine a target time cycle triggered by the trigger operation; and
display search data information corresponding to the target time cycle, where the search data information is determined according to result attributes of at least one clustering result obtained by performing result clustering on search results of the respective to-be-displayed entries corresponding to the search keyword in the target time cycle.

In a possible implementation, the apparatus further includes:
a third determination module 605, configured to determine the second search index information corresponding to the search keyword according to the following steps:
acquiring a first search index of the search keyword in each of the time cycles in the first preset period of time and acquiring a second search index of each of search terms related to the search keyword in each of the time cycles in the first preset period of time;
for each of the time cycles, determining a search index of the search keyword in the time cycle according to the first search index of the search keyword in the time cycle and the second search index of each of the search terms in the time cycle; and
determining the second search index information corresponding to the search keyword according to the search index of the search keyword in each of the time cycles.

In a possible implementation, the acquisition module 601 is further configured to, after displaying the respective to-be-displayed entries,
in response to triggering the to-be-displayed entry, acquire a search result matching the triggered to-be-displayed entry; and
the display module 602 is further configured to display the search result in a second search result page.

Reference is made to the related description in the above method embodiments for the description of the processing flow of the respective modules in the apparatus and the interaction flow between the respective modules, which will not be repeated here.

Based on the same technical concept, an embodiment of the present application further provides a computer device. Referring to FIG. 7, FIG. 7 is a schematic structural diagram of a computer device provided by an embodiment of the present application. The computer device includes:
a processor 71, a memory 72, and a bus 73. The memory 72 stores machine-readable instructions executable by the processor 71. The processor 71 is configured to execute the machine-readable instructions stored in the memory 72. When executing the machine-readable instructions, the processor 71 performs the following steps: S101, in response to receiving a search term, acquiring first search index information of a target event associated with the search term and search keywords of the target event in different attention feature dimensions, where the first search index information represents a change trend of the target event over time cycles in a first preset period of time and a search index of the target event in each of the time cycles; and S102, displaying the first search index information and the search keyword in a first search result page.

The storage 72 includes an internal memory 721 and an external memory 722. The internal memory 721 is also referred to as an internal storage, which is configured to temporarily store operation data in the processor 71 and data exchanged with an external memory 722 such as a hard disk. The processor 71 exchanges data with the external memory 722 through the internal memory 721. When the computer device is running, the processor 71 communicates with the storage 72 through the bus 73, so that the processor 71 executes the execution instructions mentioned in the above method embodiments.

An embodiment of the present disclosure further provides a computer-readable storage medium. The computer-readable storage medium is configured to store a computer program, and when the computer program is run by a processor, the steps of the method of displaying search information described in the above method embodiments are executed. The storage medium may be a volatile or non-volatile computer-readable storage medium.

A computer program product of the method of displaying search information provided in an embodiment of the present disclosure includes a computer-readable storage medium storing program codes, where instructions included in the program codes may be used to execute the steps of the method of displaying search information described in the above method embodiments, which may specifically refer to the above method embodiments, and details will not be repeated here.

The computer program product may be implemented in hardware, software, or a combination thereof. In an optional embodiment, the computer program product is embodied as a computer storage medium. In another optional embodiment, the computer program product is embodied as a software product, such as a software development kit (Software Development Kit, SDK), and the like.

It should be clearly understood by those skilled in the art that, for the convenience and conciseness of description, reference may be made to the corresponding processes in the foregoing method embodiments for the specific working processes of the above-described systems and apparatuses, which will not be repeated here. In several embodiments provided by the present disclosure, it should be understood that the disclosed system, apparatus, and method may be implemented in other manners. The apparatus embodiments described above are only illustrative. For example, the division of the units is only a logical function division, and there may be other division manners in actual implementation. For another example, a plurality of units or components may be combined or integrated into another system, or some features may be ignored or not executed. In addition, the mutual coupling, direct coupling, or communication connection shown or discussed may be through some communication interfaces, and the indirect coupling or communication connection between the apparatuses or units may be electrical, mechanical, or other forms.

The unit described as a separate part may or may not be physically separated, and the part displayed as a unit may or may not be a physical unit, that is, it may be located in one place, or may be distributed on a plurality of network units. Some or all of the units may be selected according to actual needs to achieve the objectives of the solutions of the embodiments.

In addition, the respective functional units in the respective embodiments of the present disclosure may be integrated into one processing unit, or the respective units may exist alone physically, or two or more units may be integrated into one unit.

If the functions are implemented in the form of software functional units and sold or used as independent products, the functions may be stored in a non-volatile computer-readable storage medium executable by a processor. Based on such understanding, the technical solutions of the present disclosure, or the part contributing to the prior art, or the part of the technical solutions may be embodied in the form of a software product. The computer software product is stored in a storage medium and includes several instructions for enabling a computer device (which may be a personal computer, a server, a network device, or the like) to perform all or part of the steps of the methods described in the respective embodiments of the present disclosure. The aforementioned storage medium includes various media that can store program codes, such as a USB flash drive, a mobile hard disk, a read-only memory (Read-Only Memory, ROM), a random-access memory (Random Access Memory, RAM), a magnetic disk, or an optical disc.

If the technical solutions of the present application involve personal information, products applying the technical solutions of the present application have clearly informed individuals of the rules for processing personal information and obtained their autonomous consent before processing the personal information. If the technical solutions of the present application involve sensitive personal information, products applying the technical solutions of the present application have obtained the individuals' separate consent and met the requirement for “explicit consent” before processing the sensitive personal information. For example, at a personal information collection apparatus such as a camera, a clear and conspicuous identification is set to inform individuals that they have entered the personal information collection scope and their personal information will be collected, and if individuals voluntarily enter the collection scope, they are deemed to consent to the collection of their personal information. Alternatively, in a case where an apparatus that processes personal information uses a conspicuous identification/information to inform individuals of the rules for processing personal information, the individuals' authorization is obtained by means of pop-up information or uploading their personal information by themselves. The rules for processing personal information may include information such as a personal information processor, a purpose of processing personal information, a method of processing personal information, and a type of personal information processed.

Finally, it should be noted that the above embodiments are only specific implementations of the present disclosure, which are used to illustrate the technical solutions of the present disclosure, but are not intended to limit the present disclosure, and the scope of protection of the present disclosure is not limited thereto. Although the present disclosure has been described in detail with reference to the foregoing embodiments, those of ordinary skill in the art should understand that any person skilled in the art can still modify the technical solutions described in the foregoing embodiments or can easily conceive of changes, or make equivalent replacements to some of the technical features thereof within the technical scope disclosed in the present disclosure. These modifications, changes or replacements do not cause the essence of the corresponding technical solutions to depart from the spirit and scope of the technical solutions of the embodiments of the present disclosure, and should be covered within the scope of protection of the present disclosure. Therefore, the scope of protection of the present disclosure should be subject to the scope of protection of the claims.

1. A method of displaying search information, comprising:
in response to receiving a search term, acquiring first search index information of a target event associated with the search term and search keywords of the target event in different attention feature dimensions, wherein the first search index information represents a change trend of the target event over time cycles in a first preset period of time and a search index of the target event in each of the time cycles; and
displaying the first search index information and the search keywords in a first search result page.

2. The method according to claim 1, wherein the attention feature dimensions are related to a development stage of the target event; and
the search keyword is determined according to following steps:
determining a target development stage at which the target event is; and
determining respective attention feature dimensions corresponding to the target event according to the target development stage, and determining the search keywords corresponding to the respective attention feature dimensions from full search terms related to the target event respectively.

3. The method according to claim 2, wherein the determining the search keywords corresponding to the respective attention feature dimensions from the full search terms related to the target event respectively comprises:
determining, for a first feature dimension of the attention feature dimensions, respective initial search terms with a degree of association with respect to the first attention feature dimension greater than a preset degree of association, from the full search terms; and
screening, according to a search index of the respective initial search terms in each of the time cycles in the first preset period of time, the search keyword in the first attention feature dimension from the initial search terms.

4. The method according to claim 1, wherein the attention feature dimensions are related to a user attention feature corresponding to the target event, and the user attention feature is determined in real time according to historical consumption data of respective historical search terms in the target event; and
the search keyword is determined according to following steps:
determining the user attention feature corresponding to the target event according to time when the search term is received, and using the user attention feature for second attention feature dimensions of the attention feature dimensions;
determining to-be-used keywords corresponding to the respective second attention feature dimensions from full search terms related to the target event, respectively; and
for a third attention feature dimension of the second attention feature dimensions, screening, according to a degree of correlation between the to-be-used keyword in the third attention feature dimension and the search term and a search index of the to-be-used keyword in each of the time cycles in the first preset period of time, the search keyword in the third attention feature dimension from the to-be-used keywords.

5. The method according to claim 1, wherein after displaying the search keyword, the method further comprises:
in response to triggering the search keyword, displaying, in the first search result page, second search index information corresponding to the search keyword, wherein the second search index information represents a change trend of the search keyword over time cycles in the first preset period of time and a search index of the search keyword in each of the time cycles.

6. The method according to claim 5, wherein before displaying, in the first search result page, the second search index information corresponding to the search keyword, the method further comprises:
acquiring respective to-be-displayed entries corresponding to the search keyword, wherein the to-be-displayed entries are determined according to degrees of correlation between respective to-be-screened entries and the search keyword and search indices of the to-be-screened entries in a second preset period of time; and
the displaying, in the first search result page, the second search index information corresponding to the search keyword comprises:
displaying the second search index information below the search keyword and displaying the respective to-be-displayed entries below the second search index information.

7. The method according to claim 5, wherein after displaying the second search index information below the search keyword, the method further comprises:
in response to a trigger operation on the second search index information, determining a target time cycle triggered by the trigger operation; and
displaying search data information corresponding to the target time cycle, wherein the search data information is determined according to a result attribute of at least one clustering result obtained by performing result clustering on search results of respective to-be-displayed entries corresponding to the search keyword in the target time cycle.

8. The method according to claim 5, wherein the second search index information corresponding to the search keyword is determined according to following steps:
acquiring a first search index of the search keyword in each of the time cycles in the first preset period of time and acquiring a second search index of each of search terms related to the search keyword in each of the time cycles in the first preset period of time;
for a first time cycle of the time cycles, determining the search index of the search keyword in the first time cycle according to the first search index of the search keyword in the first time cycle and the second search index of each of the search terms in the first time cycle; and
determining the second search index information corresponding to the search keyword according to the search index of the search keyword in the first time cycle.

9. The method according to claim 6, wherein after displaying the respective to-be-displayed entries, the method further comprises:
in response to triggering the to-be-displayed entry, acquiring a search result matching a triggered to-be-displayed entry; and
displaying the search result in a second search result page.

10. (canceled)

11. A computer device, comprising: a-at least one processor and a at least one memory, wherein the at least one memory stores machine-readable instructions being capable of being executed by the at least one processor, the at least one processor is configured to execute the machine-readable instructions stored in the at least one memory, and when the machine-readable instructions are executed by the at least one processor, the at least one processor executes a method of displaying search information, which comprises:
in response to receiving a search term, acquiring first search index information of a target event associated with the search term and search keywords of the target event in different attention feature dimensions, wherein the first search index information represents a change trend of the target event over time cycles in a first preset period of time and a search index of the target event in each of the time cycles; and
displaying the first search index information and the search keywords in a first search result page.

12. A non-transitory computer-readable storage medium, wherein a at least one computer program is stored on the non-transitory computer-readable storage medium, and when the at least one computer program is run by a computer device, the computer device executes a method of displaying search information, which comprises:
in response to receiving a search term, acquiring first search index information of a target event associated with the search term and search keywords of the target event in different attention feature dimensions, wherein the first search index information represents a change trend of the target event over time cycles in a first preset period of time and a search index of the target event in each of the time cycles; and
displaying the first search index information and the search keywords in a first search result page.

13. The method according to claim 2, wherein after displaying the search keyword, the method further comprises:
in response to triggering the search keyword, displaying, in the first search result page, second search index information corresponding to the search keyword, wherein the second search index information represents a change trend of the search keyword over time cycles in the first preset period of time and a search index of the search keyword in each of the time cycles.

14. The method according to claim 3, wherein after displaying the search keyword, the method further comprises:
in response to triggering the search keyword, displaying, in the first search result page, second search index information corresponding to the search keyword, wherein the second search index information represents a change trend of the search keyword over time cycles in the first preset period of time and a search index of the search keyword in each of the time cycles.

15. The method according to claim 4, wherein after displaying the search keyword, the method further comprises:
in response to triggering the search keyword, displaying, in the first search result page, second search index information corresponding to the search keyword, wherein the second search index information represents a change trend of the search keyword over time cycles in the first preset period of time and a search index of the search keyword in each of the time cycles.

16. The method according to claim 6, wherein after displaying the second search index information below the search keyword, the method further comprises:
in response to a trigger operation on the second search index information, determining a target time cycle triggered by the trigger operation; and
displaying search data information corresponding to the target time cycle, wherein the search data information is determined according to a result attribute of at least one clustering result obtained by performing result clustering on search results of the respective to-be-displayed entries corresponding to the search keyword in the target time cycle.

17. The method according to claim 6, wherein the second search index information corresponding to the search keyword is determined according to following steps:
acquiring a first search index of the search keyword in each of the time cycles in the first preset period of time and acquiring a second search index of each of search terms related to the search keyword in each of the time cycles in the first preset period of time;
for a first time cycle of the time cycles, determining the search index of the search keyword in the first time cycle according to the first search index of the search keyword in the first time cycle and the second search index of each of the search terms in the first time cycle; and
determining the second search index information corresponding to the search keyword according to the search index of the search keyword in the first time cycle.

18. The method according to claim 7, wherein the second search index information corresponding to the search keyword is determined according to following steps:
acquiring a first search index of the search keyword in each of the time cycles in the first preset period of time and acquiring a second search index of each of search terms related to the search keyword in each of the time cycles in the first preset period of time;
for a first time cycle of the time cycles, determining the search index of the search keyword in the first time cycle according to the first search index of the search keyword in the first time cycle and the second search index of each of the search terms in the first time cycle; and
determining the second search index information corresponding to the search keyword according to the search index of the search keyword in the first time cycle.

19. The computer device according to claim 11, wherein the attention feature dimensions are related to a development stage of the target event; and
the search keyword is determined according to following steps:
determining a target development stage at which the target event is; and
determining respective attention feature dimensions corresponding to the target event according to the target development stage, and determining the search keywords corresponding to the respective attention feature dimensions from full search terms related to the target event respectively.

20. The computer device according to claim 19, wherein the determining the search keywords corresponding to the respective attention feature dimensions from the full search terms related to the target event respectively comprises:
determining, for a first feature dimension of the attention feature dimensions, respective initial search terms with a degree of association with respect to the first attention feature dimension greater than a preset degree of association, from the full search terms; and
screening, according to a search index of the respective initial search terms in each of the time cycles in the first preset period of time, the search keyword in the first attention feature dimension from the initial search terms.

21. The computer device according to claim 11, wherein the attention feature dimension are related to a user attention feature corresponding to the target event, and the user attention feature is determined in real time according to historical consumption data of respective historical search terms in the target event; and
the search keyword is determined according to following steps:
determining the user attention feature corresponding to the target event according to time when the search term is received, and using the user attention feature for second attention feature dimensions of the attention feature dimensions;
determining to-be-used keywords corresponding to the respective second attention feature dimensions from full search terms related to the target event, respectively; and
for a third attention feature dimension of the second attention feature dimensions, screening, according to a degree of correlation between the to-be-used keyword in the third attention feature dimension and the search term and a search index of the to-be-used keyword in each of the time cycles in the first preset period of time, the search keyword in the third attention feature dimension from the to-be-used keywords.
